(19) United States
(12) Patent Application Publication
(10) Pub. No.: US 2005/0286044 A1
(43) Pub. Date: Dec. 29, 2005

(54) Method and apparatus for qualitatively analyzing uniformity in microelectromechanical devices

(76) Inventor: Andrew Huibers, Palo Alto, CA (US)

Correspondence Address: REFLECTIVITY, INC., 350 POTRERO AVENUE, SUNNYVALE, CA, 94085, US

(21) Appl. No.: 10/875,602

(22) Filed: Jun. 23, 2004

(51) Int. Cl. G01N 21/88

(52) U.S. Cl. 356/237.1

(57) ABSTRACT

The method and apparatus of the invention qualitatively evaluate the product quality of a wafer having microelectromechanical devices that have deflectable reflective planar members using an optical technique. At least three wafer images are captured for different reflected light from different spatial directions. The brightness of the captured images is compared between the captured images so as to obtain qualitative information of the deflection distribution of the deflectable members. The qualitative information can be used as basis for further product quality analysis or as standard for determining whether to discard the product.

### TECHNICAL FIELD OF THE INVENTION

The present invention relates to the field of microelectromechanical devices, and more particularly to methods and apparatus for testing microelectromechanical devices after fabrication.

### BACKGROUND OF THE INVENTION

Microelectromechanical (MEMS) devices have found many applications in basic signal transductions. For example, MEMS-based spatial light modulators are transducers that modulate incident light in a spatial pattern in response to optical or electrical inputs. The incident light may be modulated in phase, intensity, polarization, or direction. This modulation may be accomplished through the use of a variety of materials exhibiting magneto-optic, electro-optic, or elastic properties. Such spatial light modulators have many applications, including optical information processing, display systems, and electrostatic printing.

A typical microelectromechanical device contains one or more functional members that are formed on a substrate in a particular pattern, which determines the operation and performance of the microelectromechanical device. For example, a typical micromirror-based spatial light modulator consists of an array of mirror plates that are formed on a substrate. The mirror plates are individually addressable and deflectable with electrostatic fields so as to modulate incident light. Successful modulations clearly depend upon positions of the mirror plates in operation.

For quality assurance purpose, it is often desired to measure the functional members of microelectromechanical device products after fabrication.

Therefore, what is desired is a method and apparatus for testing a fabricated microelectromechanical device.

### SUMMARY OF THE INVENTION

The objects and advantages of the present invention will be obvious, and in part appear hereafter and are accomplished by the present invention that provides a method and apparatus for operating pixels of spatial light modulators in display systems. Such objects of the invention are achieved in the features of the independent claims attached hereto. Preferred embodiments are characterized in the dependent claims. In the claims, only elements denoted by the words “means for” are intended to be interpreted as means plus function claims under 35 U.S.C. §112, the sixth paragraph.

### BRIEF DESCRIPTION OF DRAWINGS

While the appended claims set forth the features of the present invention with particularity, the invention, together with its objects and advantages, may be best understood from the following detailed description taken in conjunction with the accompanying drawings of which:

FIG. 1 is a perspective view of a wafer having a plurality of dies, each of which has an array of fabricated micromirrors;

FIG. 2 is a perspective view of a portion of a die having an array of micromirrors after removal of the sacrificial material;

FIG. 3 is a cross-sectional view of a portion of a die having an array of mirror plates in reflecting incident light with the mirror plates at different positions;

FIG. 4 is an observed illumination pattern of the reflected light in FIG. 3;

FIG. 5 is a measurement setup for measuring the uniformity of the micromirrors on a wafer according to an embodiment of the invention;

FIG. 6 is a diagram illustrating a measured illumination pattern of the dies on a wafer with each dies having an array of micromirrors, wherein a majority of mirror plates of the micromirror arrays is parallel to the substrate after removal of the sacrificial material;

FIG. 7 is a diagram illustrating a measured illumination pattern of the dies on a wafer with each dies having an array of micromirrors, wherein a majority of mirror plates of the micromirror arrays is at a rotated angle towards the substrate after removal of the sacrificial material;

FIG. 8 is a diagram illustrating a measured illumination pattern of a the dies on a wafer with each dies having an array of micromirrors, wherein a majority of mirror plates of the micromirror arrays is at a rotated angle away from the substrate as compared to FIG. 7 after removal of the sacrificial material;

FIG. 9a demonstratively illustrates an illumination pattern on the dies of a wafer;

FIG. 9b demonstratively illustrates an illumination pattern of a die having an array of micromirrors;

FIG. 10 demonstratively illustrates an exemplary user-interface for enabling a user to performing the method of the invention through a computer;

FIG. 11a demonstratively illustrates an exemplary automatic control panel in FIG. 10;

FIG. 11b demonstratively illustrates an exemplary manual control panel in FIG. 10;

FIG. 11c demonstratively illustrates an exemplary setting panel in FIG. 10; and

FIG. 12 diagrammatically illustrates an exemplary computing system for implementing embodiments of the invention.

### DETAILED DESCRIPTION OF THE EMBODIMENTS

The invention provides a method and apparatus of evaluating the quality of microelectromechanical devices having deflectable reflective planar members using optical techniques. Specifically, product quality characterized in terms of position uniformity of the mirror plates of a micromirror-based spatial light modulator is evaluated by the reflectance of the mirror plates and statistical analysis of the illumination pattern of the reflected light from the mirror plates on a display target. Accordingly, an apparatus for performing the measurement and analysis is provided.

The apparatus comprises a light source providing substantially collimated light for illuminating the mirror plates, and an image capture device for capturing reflected light from the mirror plates so as to generate illumination patterns. The light has a wavelength that corresponds to the dimensions of the mirror plate and the gap between adjacent mirror plates. Particularly, the light from the light source has a wavelength equal to or less than the dimension of the mirror plate or the gap size, whichever is smaller.

The illumination patterns comprising a set of images of a wafer are statistically analyzed so as to obtain a first order evaluation of the position uniformity of the mirror plates. Specifically, reflected light from the mirror plates after removal of the sacrificial materials are measured at a set of different positions corresponding to reflected light from mirror plates tilted from approximately from −1.0 degree (titled in one direction from the substrate) to +1.0 degree (tilted in another direction from the substrate). By statistically analyzing selected optical parameters describing the illumination pattern, such as the brightness distribution of the illumination pattern, quantitative evaluation of the mirror plate positions is obtained. Such quantitative evaluation can be used as basis for further product quality analysis.

The inspection system of the present invention results in a high resolution, is simple, fast, reliable, compact, portable, and allows for easy identification and documentation of wafer assembly or die assembly defects. The inspection system can comprise one or more of a white light point source, a diffuser, a narrow band filter, collimating lens, steering mirrors, detectors, imaging optics, CCD camera and control monitor or screen. The inspection system allows for non-uniformity detection in an entire wafer or a die surface in a single field of view, thus reducing inspection time. In contrast, the prior art relies on manual inspection of wafers under bright poly- or mono-chromatic light. Manual inspection can be problematic, unreliable and time consuming.

In an embodiment of the invention, a system for qualitatively evaluating the product quality of a wafer having a set of dies, each die having an array of micromirrors is provide. The system comprises: a light source providing a light beam; a set of optics for collimating the light beam; a wafer stage for holding the wafer such that the micromirrors of the wafer reflect the light beam; an image capture device that captures the reflected light from the micromirrors of the wafer and generates a set of images of the wafer, each wafer image corresponding to a beam of reflected light in a particular spatial direction; and different wafer images correspond to reflected light in different directions; and a means for comparing the brightness of the captured images to each other so as to qualitatively evaluate the micromirrors.

In another embodiment of the invention, a method of qualitatively evaluating the product quality of a wafer having a set of dies, each die having an array of micromirrors is disclosed. The method comprises: illuminating the wafer with a light beam; capturing a set of wafer images, one of which is associated with a number of micromirrors having mirror plates tilted in one direction from a substrate on which the micromirrors are formed, another one of which is associated with a number of micromirrors having mirror plates substantially parallel to the substrate, and yet another one of which is associated with a number of micromirrors having mirror plates tilted in another direction from the substrate or parallel to the substrate; and comparing the brightness of the captured images so as to qualitatively evaluate the micromirrors.

In yet another embodiment of the invention, a method of qualitatively evaluating the product quality of a wafer having a set of dies, each die having an array of micromirrors is disclosed. The method comprises: accepting a set of controlling parameters from a user through a user-interface generated by a computer-executable program code; and based on the received parameters and under a control of a computer; illuminating the wafer with a light beam; capturing a set of wafer images, one of which is associated with a number of micromirrors having mirror plates tilted in one direction from a substrate on which the micromirrors are formed, another one of which is associated with a number of micromirrors having mirror plates substantially parallel to the substrate, and yet another one of which is associated with a number of micromirrors having mirror plates tilted in another direction from the substrate; and comparing the brightness of the captured images so as to qualitatively evaluate the number of micromirrors substantially at a desired position in each die.

In yet another embodiment of the invention, a computer-readable medium having computer executable instruction of qualitatively evaluating the product quality of a wafer having a set of dies, each die having an array of micromirrors is disclosed. The medium comprises: accepting a set of controlling parameters from a user through a user-interface generated by a computer-executable program code; and based on the received parameters and under a control of a computer, illuminating the wafer with a light beam; capturing a set of wafer images, one of which is associated with a number of micromirrors having mirror plates tilted in one direction from a substrate on which the micromirrors are formed, another one of which is associated with a number of micromirrors having mirror plates substantially parallel to the substrate, and yet another one of which is associated with a number of micromirrors having mirror plates tilted in another direction from the substrate; and comparing the brightness of the captured images so as to qualitatively evaluate the number of micromirrors substantially at a desired position in each die.

In yet another embodiment of the invention, a method of qualitatively evaluating the product quality of a wafer having a set of dies, each die having an array of micromirrors is disclosed. The method comprises: illuminating a die on the wafer with a light beam; capturing an image of the illuminated die, wherein the image presents a brightness distribution; and evaluating the uniformity of the micromirrors across the wafer based on the brightness distribution.

In yet another embodiment of the invention, a method of qualitatively evaluating the product quality of a wafer having a set of dies, each die having an array of micromirrors is disclosed. The method comprises: illuminating a first and second die on the wafer with a light beam; capturing an image for each of the illuminated dies, wherein each of the images presents a brightness distribution; and evaluating the uniformity of the micromirrors across the wafer based on the brightness distributions of the dies.

The present invention is applicable to microelectromechanical devices having deflectable reflective planar members that require uniformity after releasing. For simplicity and demonstration purposes only, the present invention will be discussed with reference to spatial light modulators having micromirrors, each of which has a deflectable reflective mirror plate. Those skilled in the art will certainly appreciate that the following examples are not be interpreted as a limitation. Rather, other variations within the spirit of the invention are also applicable and should not be excluded from the invention.

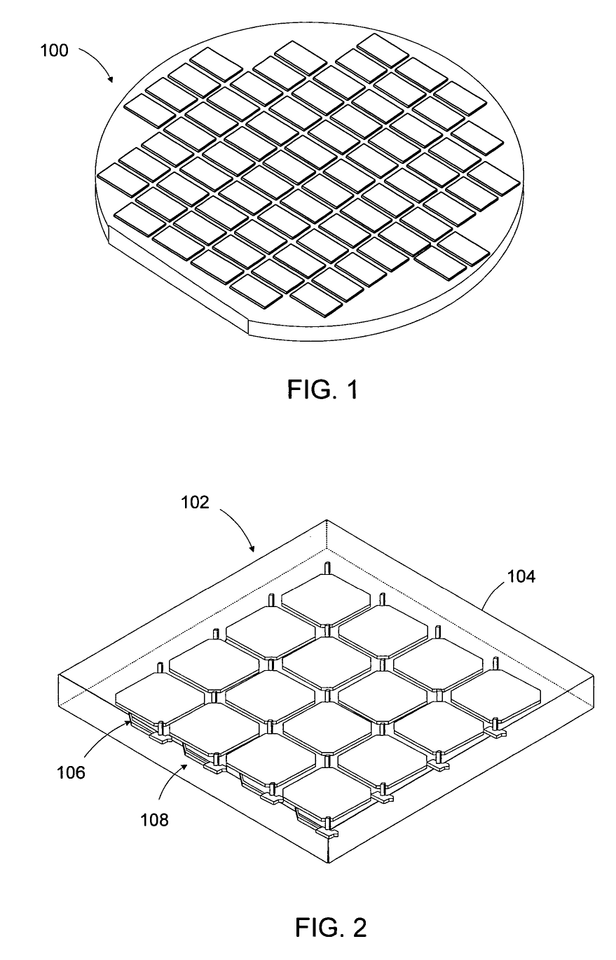

Referring to the drawings, FIG. 1 illustrates a perspective view of wafer 100 having a plurality of dies (e.g. rectangular dies) after removal of the sacrificial material. Each die may have thousands or millions of micromirror devices arranged into a micromirror array. Each die can be a complete spatial light modulator or a part of a spatial light modulator. As an example, the micromirror array can be formed on a semiconductor substrate that further comprises an array of electrodes and circuitry for addressing and deflecting the mirror plates of the micromirror array. In this situation, the die can be a complete spatial light modulator. Alternatively, the micromirror array can be formed on a glass substrate that is separate from a semiconductor substrate on which the addressing electrodes and circuitry are formed; and the two substrates are placed proximate or bonded to each other for enabling the electrodes to address and deflect the mirror plates of the micromirror array. In this situation, each die in FIG. 1 comprises the micromirrors and is only a portion of a spatial light modulator. After fabrication, each die will be separated and assembled with another die having the electrodes and circuitry, which is not shown in the figure.

FIG. 2 is a perspective view of a portion of a die in FIG. 1. In this particular example, the die comprises an array of micromirrors 106 formed on glass substrate 104. Each micromirror operates in a binary-mode, that is, the micromirror switches between an ON state and OFF state in operation. In the ON state, the micromirror reflects incident light so as to generate a “bright” pixel on a display target; and in the OFF state, the micromirror reflects the incident light so as to generate a “dark” pixel on the display target. In a number of embodiments of the invention, the micromirror array is constructed having a pitch (the center-to-center distance between adjacent micromirrors) of 25 micrometers or less, or 10.16 micrometers or less, or from 4.38 to 10.16 micrometers. The gap between adjacent micromirrors is approximately of 0.5 micrometers or less, or from 0.1 to 0.5 micrometer. And the mirror plate of the micromirror has a dimension of from 20 micrometers to 10 micrometers. The mirror plates of the micromirror array are held below the glass substrate by hinges such that the mirror plates can rotate relative to the glass substrate. The mirror plates as show in the figure are substantially square; and the hinges are hidden under the mirror plates. This configuration, however, is not an absolute requirement. Instead, the mirror plate can take any desired shapes; and the hinge cane be formed at any suitable relative positions to the mirror plates and the substrate as long as the mirror plates can rotate relative to the glass substrate.

The micromirrors can be formed in a variety of ways. Regardless of the method selected, a sacrificial material is often used in forming the functional members of the micromirror devices. As a way of example, the micromirror array as shown in FIG. 2 can be formed in a following way. With prepared glass substrate 104, a sacrificial layer having selected sacrificial material, such as amorphous silicon is deposited on the glass substrate. A mirror plate layer is then deposited and patterned for forming the mirror plate array. Then another sacrificial layer is deposited and patterned for forming other functional members, such as hinges and posts of the micromirror array. On the patterned sacrificial layer(s), the hinges and posts can be formed but not necessarily in that order. Based on the particular design of the micromirror array, other sacrificial layers may be deposited as appropriate.

After forming the desired functional members, the sacrificial layers are removed using one or more suitable methods, such as a chemical etching process with selected spontaneous vapor phase chemical etchant(s), such as xenon difluoride.

The micromirrors can also be formed in other suitable methods. For example, the micromirror substrate can be formed on a transfer substrate that is light transmissive. Specifically, the micromirror plate can be formed on the transfer substrate and then the micromirror substrate along with the transfer substrate is attached to another substrate such as a light transmissive substrate followed by removal of the transfer substrate and patterning of the micromirror substrate to form the micromirror.

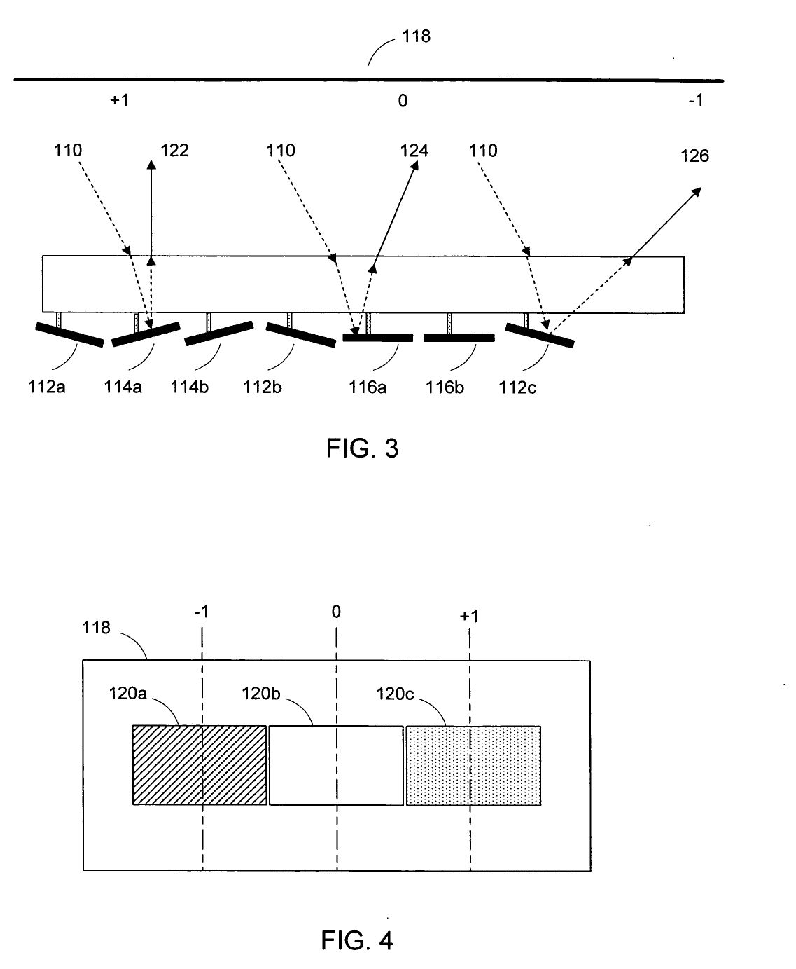

After removal of the sacrificial layers, all of the mirror plates of the micromirror array are expected to be in a uniform position—that is parallel to the glass substrate. This ideal micromirror array device, after removal of the sacrificial layers may not always be obtained due to many factors, such as uneven removal of the sacrificial layers during the etching process and surface stiction of the mirror plates to the substrate after etching. As a result, the mirror plates may be in different natural positions after removal of the sacrificial layers, such as that shown in FIG. 3.

Referring to FIG. 3, a cross-sectional view of the portion of a micromirror in FIG. 2 after an exemplary etching process is illustrated therein. It is assumed that mirror plates 112a, 112b, and 112c are in the same or similar rotation positions (rotate away from the glass substrate) after removal of the sacrificial material. Mirror plates 114a and 114b are rotated towards the glass substrate; and mirror plates 116a and 116b are parallel to the glass substrate after removal of the sacrificial material. Because of their different rotation positions, a collimated light beam will be reflected into different spatial directions and generate separate images at different locations on a display target. It is worthwhile to point out that the micromirror array after removal of the sacrificial layers in FIG. 3 is for demonstration purpose only, wherein the mirror plates are randomly positioned; and the uniformity of the mirror plates is in the worst scenario. Generally, a majority of the mirror plates are uniformly positioned in a practical fabrication process. Nevertheless, the theory and the method as described in the following with reference to FIG. 3 are general and applicable to micromirror arrays with any other position scenarios of the mirror plates.

In order to analyze the uniformity of the mirror plate positions after removal of the sacrificial layers so as to evaluate the product quality of the fabricated micromirror array, an optical measurement technique is employed as shown in the figure. According to the invention, a beam of collimated light 110 is directed to the mirror plates of the micromirror array. The light beam travels through the glass substrate and strikes the mirror plates. The light beam is then reflected into different spatial directions by the mirror plates. Specifically, mirror plates 114a and 114b reflect the light beam into reflected light beam 122; and generate an image of mirror plates 114a and 114b at a location denoted by +1 degree on display target 118. Mirror plates 116a and 116b reflect the light beam into reflected light beam 124; and generate an image of mirror plates 116a and 116b at another location denoted by 0 degree on the display target. Mirror plates 112a, 112b, and 112c reflect the light beam into reflected light beam 126; and generate an image of these mirror plates at yet another location represented by −1 degree on the display target as shown in the figure.

FIG. 4 demonstratively illustrates the set of images generated by the reflected light beams. Referring to FIG. 4, three images 120a, 120b, and 120c respectively generated by reflected light beams 122, 124, and 126 are at different locations represented by −1, 0, and +1 degree corresponding to the mirror plates at different rotation positions. That is, the characteristics, such as the relative brightness and relative distribution of the brightness of the images are associated with the rotation positions of mirror plates. Therefore, information of the mirror plate positions can be obtained by statistically analyzing these images. Specifically, if the 0 degree image has the highest brightness among all of the captured images, it is said that majority of the mirror plates are parallel to the substrate after removal of the sacrificial layers. The brightness differences between the 0 degree image and other captured images is determined by the difference between the numbers of mirror plates parallel to the substrates and non-parallel to the substrate. If the 0 degree image is not the image having the highest brightness, majority of the mirror plates are not parallel to the substrate; instead they are in a rotation position associated with the image has the highest brightness. For example, if the image at location −1 degree on the display target has the highest brightness among the captured images, majority of the mirror plates are rotated towards the substrates as the mirror plates 114a and 114b in FIG. 3. For another example, if the image at location +1 degree on the display target has the highest brightness among the captured images, majority of the mirror plates are rotated towards the substrates as the mirror plates 112a, 112b, and 112c in FIG. 3.

For simplicity and demonstration purposes, FIG. 3 and FIG. 4 illustrate mirror plates in three different rotation positions. In reality, mirror plates may be in a variety of rotation positions after removal of the sacrificial layers. As a result, the reflected light from the mirror plates can be in more than three different spatial directions; and the number of images can be more than three. According to the invention, the set of captured images at different locations on the display target are assigned with a series of diffraction orders from −m to +n, wherein m and n are positive integers, but not necessarily the same. These orders preferably describe the mirror plates having tilted angle of from −km (e.g. −2.5) degrees to +km (e.g. +2.5) degrees with the tilted angle of 0 degree (parallel to the substrate) corresponds to the 0^{th} order image. In a situation when a non-parallel natural resting state of the mirror plates is desired (e.g. the mirror plates as designed are expected to have p degree at natural resting state with p is a non-zero integer number), the image corresponding to the mirror plate at p angle is assigned with the 0^{th} order. When the wavelength of the light source is much smaller than the characteristic dimension of the micromirror array, such as the pitch size L, the diffraction order can be approximately calculated with the following equation:

$$k \approx \frac{λ}{L} \frac{180}{π} \frac{1}{2} ,$$

wherein λ is the wavelength of the incident light. As an example, assuming that the pitch size of the micromirror array is 14 microns, the diffraction order k is around 1.

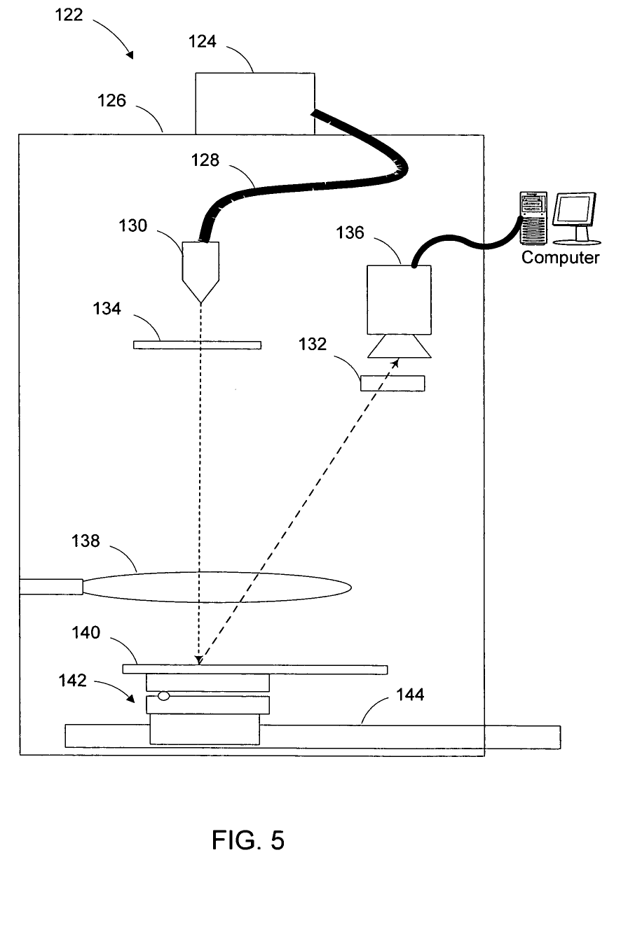

Referring to FIG. 5, an exemplary experimental setup for performing the method of the present invention is schematically illustrated therein. System 122 comprises light source 124 with attached fiber optic cable 128 connected to microscope objective 130, neutral density filter 132, diffuser 134, condenser lens 138, vacuum chuck 140, motorized tilt sample holder 142, wafer loading rail 144, and image capture device 136. Sample holder 142 can be of any suitable forms, such as a stage having a supporting surface for holding the device to be measured. The sample holder can equipped with an automation system such as a motor, but necessarily. The sample holder is preferably having a supporting surface whose position can be adjusted three-dimensionally. For example, the surface of the sample holder can be tilted such that the reflective surface of the sample to be measured can be tilted. In this way, the reflected light from the reflective surface of the sample to be measured can be directed into any desired directions.

The light source emits a beam of light for the measurement system. The light has a wavelength substantially less than the minimum dimensions of the mirror plate. The light from the light source is conducted to the microscope objective through the fiber optic cable. The microscope objective forms a point light source and emitting light passing through the diffuser. The condensing lens preferably having a 6″ or 8″ diameter collimates the diffused light and illuminates the wafer vacuum chuck wherein wafer to be tested is held. The vacuum chuck is provided for accurately positioning the wafer to be tested in the illumination imaging light path of the system, and for preventing the wafer from moving when the motorized tilt stage is in operation. The vacuum chuck is mounted to the motorized tilt state; and the motorized tilt stage is mounted on the wafer loading rail. The wafer loading rail provides the easy wafer loading and unloading when the station is covered.

The reflected light from the mirror plates passes through the neutral density filter and is collected by the condensing lens and focused into the image capture device. The image capture device can be a display target, a CCD or any other type of devices having the function of capturing images. The image capture device is preferably connected to an automated image analyzer, such as a computer having programmed codes for analyzing the captured images.

The captured set of images is then statistically analyzed to obtain the qualitative information of the angle distribution of released mirror plates across a wafer. Images captured at different locations are assigned with a series of orders ranging from −m to +n with the 0^{th} order assigned to the image corresponding to the mirror plates having desired natural resting angle. The desired natural resting angle can be 0 degree as the mirror plates are parallel to the substrate. The desired natural resting angle can also be non-zero where the mirror plates have a certain uniform angle to the substrate. The negative angles represent mirror plates tilted in one direction from the glass substrate; and the positive angles represent the mirror plates that are tilted in another direction from the glass substrate. The assignment scheme is certainly not absolute. Rather, other assignment schemes are also applicable. For example, the negative angles represent mirror plates tilted in one direction from the glass substrate; while the positive angles represent the mirror plates that are tilted in another direction from the glass substrate.

In the following, the image analysis method will be discussed in detail with examples in which three orders ranging from −1 to +1 are used to describe the tilted angles of the mirror plates in a wafer for simplicity purpose. Of course, higher orders can be employed in practice as appropriate.

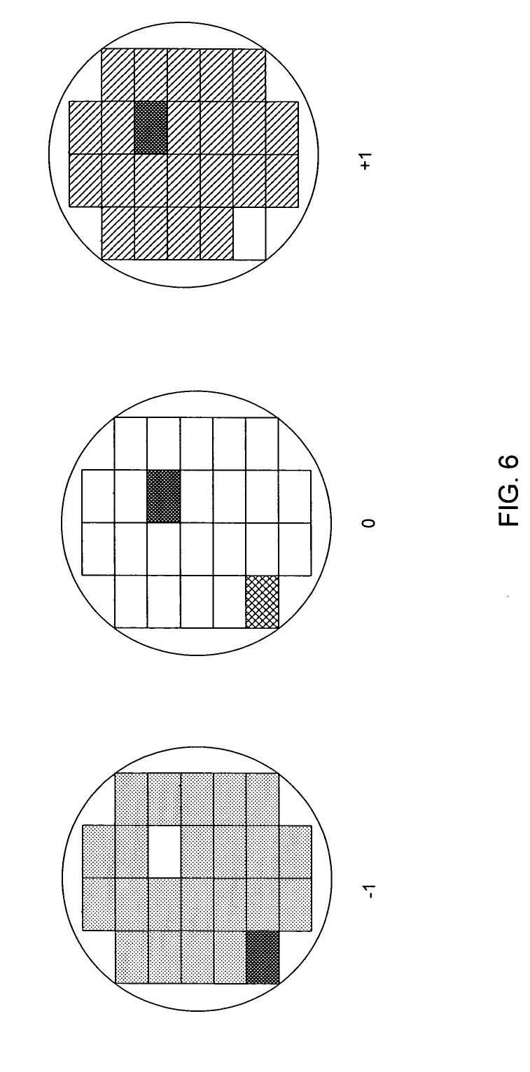

FIG. 6 schematically illustrates a set of captured images in a measurement for a wafer wherein the majority of mirror plates are parallel to the glass substrate. Three wafer images with the orders −1, 0, and +1 are generated by the reflected light from the mirror plates in the wafer. Each rectangle in a wafer image is an image of a die in the wafer. Different filling patterns of the rectangles represent different levels of brightness. Specifically, the image of the 0^{th} order has the highest brightness due to the fact the majority of the mirror plates are parallel to the glass substrate. The image of the 0^{th} order has some dark rectangles as shown in the figure, which infers that these dark dies of the wafer have different tilt angles of the mirror plates. The wafer image of the −1^{st} order corresponds to the mirror plates having tilted angles towards the glass substrate, and has a lower average brightness than the wafer image of the 0^{th} order. The brightness difference between the −1^{st} order wafer image and wafer image of the 0^{th} order indicates the difference in the number of mirror plates parallel to the glass substrate and the number of mirror plates having angles tilted in one direction the glass substrate. The larger the brightness difference, the larger the number of mirror plates parallel to the glass substrate is. The wafer image of the +1^{st} corresponds to the mirror plates having tilted angles in another direction from the glass substrate. This wafer image has a lower brightness than the 0^{th} order wafer image, inferring that only a mall number of mirror plates are tilted in one direction from the glass substrate. The brightness difference between the +1^{st} order wafer image and wafer image of the 0^{th} order indicates the difference in the number of mirror plates parallel to the glass substrate and the number of mirror plates having angles tilted in another direction from the glass substrate.

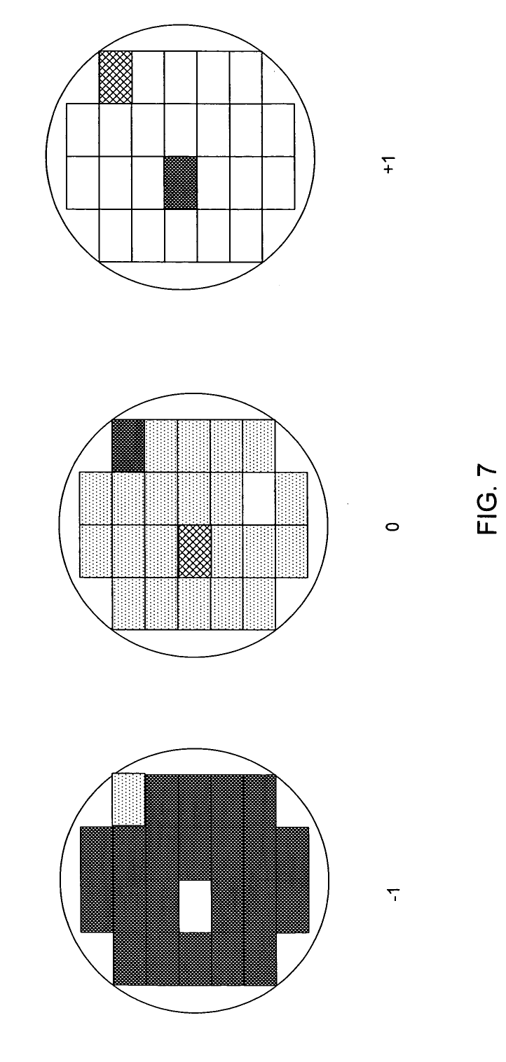

FIG. 7 schematically illustrates a set of captured images in a measurement for a wafer wherein the majority of mirror plates are tilted in one direction from the glass substrate. The +1 wafer image has the highest average brightness among the captured images with different orders. The 0^{th} order wafer image has a lower average brightness than that of the +1^{st} order wafer image; and the average brightness of the −1^{st} order wafer image may or may not be lower than the average brightness of the 0^{th} order wafer image. The differences between the brightness of the wafer images indicate the differences of the quantities of mirror plates in different tilted angles.

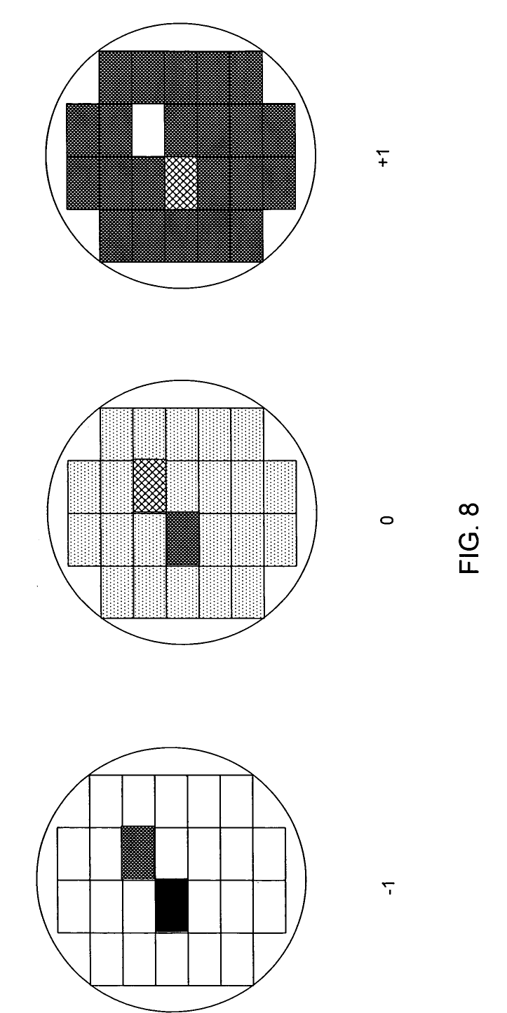

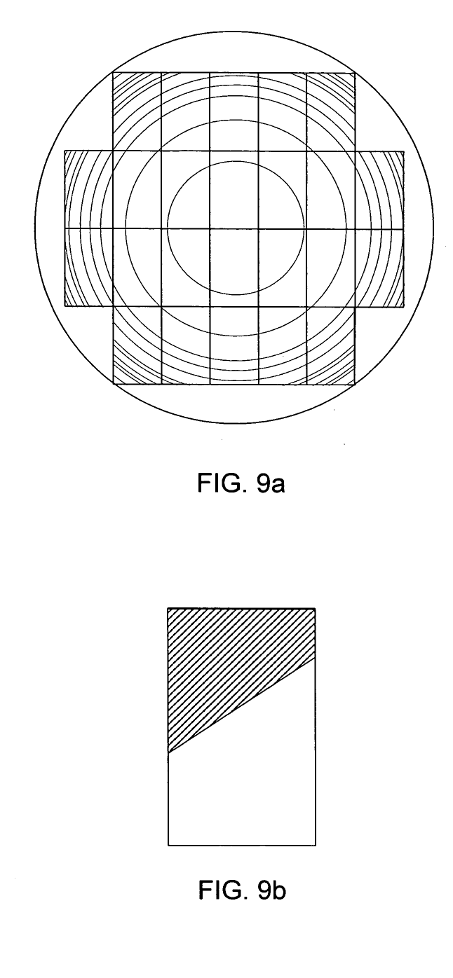

FIG. 8 illustrates the captured wafer images of a wafer wherein the majority of the mirror plates have tilted angles in one direction from the glass substrate. Accordingly, the wafer image of the −1^{st} order has the highest brightness. The brightness differences between the −1^{st} order wafer image and the 0^{th} and −1^{st} order wafer images indicate the number of mirror plates having tilted angles on one direction from the glass substrate, and the number of mirror plates having tilted angles otherwise.

Based on the captured wafer images and the image analysis method as described in FIGS. 6 to 8, qualitative information on the angle distribution of the mirror plates can be obtained. Such qualitative information can thus be used as basis for further product quality analysis or can also be used as a standard in determining whether the wafer product is NOT an acceptable product, which should be discarded. Moreover, the uniformity information can be used for the following processes if desired. For example, a micromirror-based spatial light modulator may comprise two substrates with an array of micromirrors being formed on a glass substrate, and an array of electrodes and circuitry being formed on a semiconductor substrate. During the fabrication, the micromirror array and the electrode and circuitry array are fabricated separately and assembled together afterwards such that the micromirrors of the glass substrate can be individually addressed and actuated by the electrodes, as set forth in US patent P002-US, P008-US, P019-US, and P085-US, the subject of each being incorporated herein by reference. Before the assembling process, “good” micromirror dies (i.e. the micromirror dies satisfying the predetermined quality criterion) and “bad” micromirror dies (i.e. the dies not satisfying the criterion) on the glass wafer can be identified across the wafer according to the uniformity information of the wafer. On the other wafer, the “good” and “bad” electrode and circuitry dies can also be identified using other inspection methods. For at least cost-effective purposes, a semiconductor wafer having a suitable number and distribution of the “bad” and “good” electrode and circuitry dies is preferably selected for matching a given glass wafer so as to statistically optimize the production yield. The selected semiconductor wafer having the electrode and circuitry dies is then assembled with the glass wafer; and broken into assembled dies. The assembled dies may receive further treatments, such as surface treatments or can be packaged for delivery to customers.

In practical measurements, the captured wafer images might not have distinguishable brightness as illustrated in FIGS. 6 to 8. Higher order images, such as ±2^{nd} order or even higher images may be used to analyze the images with the same analysis method applied in analyzing images in FIGS. 6 to 8.

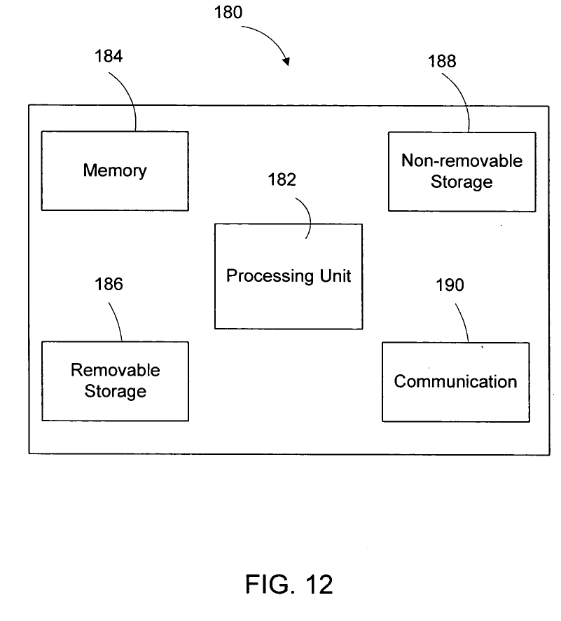

The image capture and analysis of the invention can be implemented as computer-executable instructions stored in a computer-readable medium, such as a storage in the computing system. Referring to FIG. 12, one exemplary computing system for implementing embodiments of the invention includes a computing device, such as computing device 180. Although such devices are well known to those of skill in the art, a brief explanation will be provided herein for the convenience of other readers. In its most basic configuration, computing device 180 typically includes at least one processing unit 182 and memory 184. Depending on the exact configuration and type of computing device, memory 184 can be volatile (such as RAM), non-volatile (such as ROM, flash memory, etc.) or some combination of the two.

Additionally, device 180 may also have other features and/or functionality. For example, device 180 could also include additional removable and/or non-removable storage including, but not limited to, magnetic or optical disks or tape, as well as writable electrical storage media. Such additional storage is illustrated in FIG. 12 by removable storage 186 and non-removable storage 188. Computer storage media includes volatile and nonvolatile, removable and non-removable media implemented in any method or technology for storage of information such as computer readable instructions, data structures, program modules or other data. The memory, the removable storage and the non-removable storage are all examples of computer storage media. Computer storage media includes, but is not limited to, RAM, ROM, EEPROM, flash memory or other memory technology, CDROM, digital versatile disks (DVD) or other optical storage, magnetic cassettes, magnetic tape, magnetic disk storage or other magnetic storage devices, or any other medium which can be used to store the desired information and which can accessed by the device. Any such computer storage media may be part of, or used in conjunction with, the device.

The device may also contain one or more communications connections 190 that allow the device to communicate with other devices (such as the other functional modules in FIG. 5). The communications connections carry information in a communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. As discussed above, the term computer readable media as used herein includes both storage media and communication media.

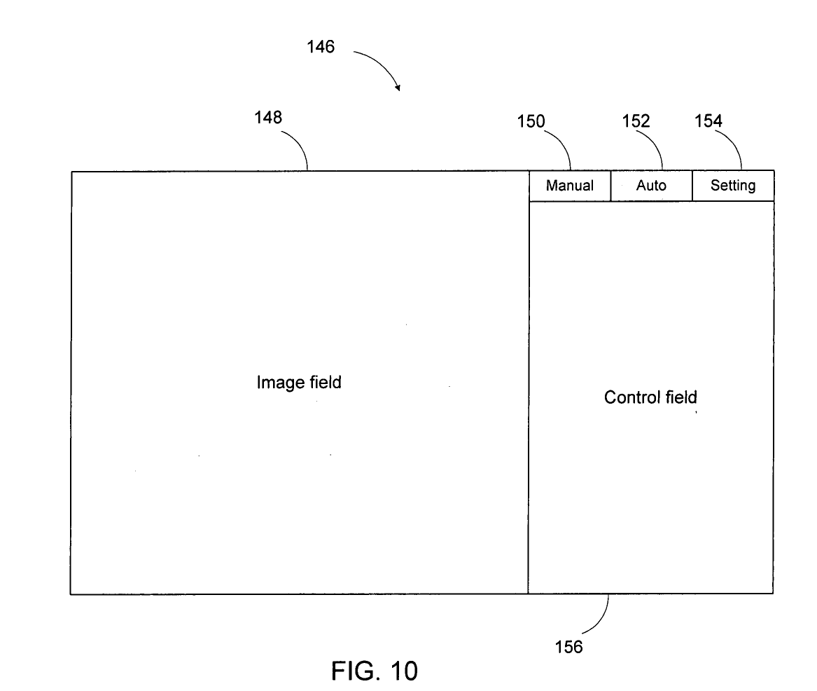

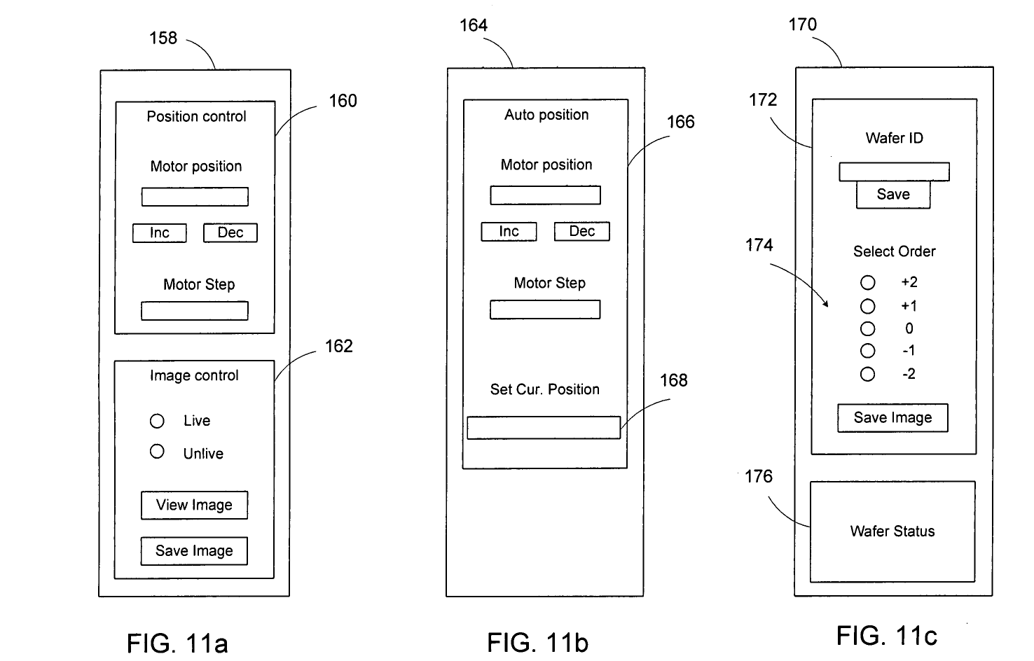

For facilitating the image capture and analysis using the computing system as described above, a friendly user-interface is further provided. As a way of example, FIG. 10 demonstratively illustrates a user-interface (UI) for image capture and analysis according to an embodiment of the invention. Referring to FIG. 10, UI 146 comprises image field 148, control field 156, control selection menus 150, 152, and 154. The image field displays the captured wafer images, or display other related images. The image field may have other optional features or tools, such as grids and image editing tools for assisting the user to analysis the images. The image field may also have multiple image displaying windows such that multiple images can be displayed and analyzed simultaneously. The control selection menu comprises manual control 150, auto control 152, and system setting 154. The user may select to perform the image capture and analysis manually by selecting manual option 150. Upon such selection, a corresponding control panel is presented in control field 156. An exemplary manual control panel is illustrated in FIG. 11a.

Referring to FIG. 11a, manual control panel 158 comprises position control panel 160 and image control panel 162. The position control panel further comprises a text input window of motor position, which allows the user to initiate the position of the motorized tilted stage 142 in FIG. 3 and/or controlling adjusting the position of the motorized tilted stage during measurements. The “Inc” and “Dec” buttons are positioned proximate to the text input window for enabling the user to adjust the input number either incrementally or decrementally. The motor step text input is provided in the control panel for adjusting the progressive step of the motorized tilt stage.

The image control panel provides a selection between “live” and “unlive” image display. When the “live” is selected, the captured wafer image is displayed in the display field in a real-time fashion. When the “unlive” is selected, the captured wafer images are stored in a memory of either the computer or a peripheral storage system of the computer. The display field presents images selected by the user. Based on the user selection of “live” or “unlive”, desired images are displayed by activating the “view image” button. The displayed images can be saved upon the activation of the “save image” button”. In a preferred embodiment of the invention, activation of the “save image” button prompts a pop up window asking path information for the images to be saved. Alternatively, the “save image” button is associated with a default file path.

In addition to the functions described above, the position control panel and the image control panel may have other desired functions, such as functions for controlling the optical elements in the system and image pre-processing control tools, such as image exposure time control, image smooth control and image edge control.

Referring back to FIG. 10, the UI further comprises auto menu selection 152 which active prompts auto control panel 164 as shown in FIG. 11b for automatically performing image capture and analysis. Referring to FIG. 11b, auto control panel 164 comprises auto-position control 166 and “set current position” control 168. The auto position control (166) further comprises a text input bar “motor position” for allowing the user to initiate and/or adjusting during measurements the position of the motorize tilt stage in FIG. 3. The “Inc” and “Dec” buttons enable the use to increase or decrease the input value in the text input bar of “motor position”. A “motor step” text input is provided for allowing the user to select desired progressive step for the motor of the motorized tile stage. As an optional feature, a “set current position” text input field is provided for allowing the user to instruct the motorized tilt stage to start from the input position in the field. Given the parameters, the measurement system automatically captures a set of wafer images under the control of the program with given parameters.

The UI in FIG. 10 also provides a menu of “setting” 154 that prompts a system setting panel for allowing the users to set required parameters for the measurement system. An exemplary system setting panel 170 is demonstratively illustrated in FIG. 10c. Referring to FIG. 1c, the system setting panel comprises parameter setting window 172 and wafer monitoring window 176. The parameter setting window (172) comprises “wafer ID” text input field that accept the identification number of the wafer being measured. The “save” button initiates the saving operation of the input wafer ID number. The parameter setting window (172) further comprises “select order” 174 that allows for the use to select the order of the image to be captured. For example, when the “0^{th} order” is selected, the system measures the 0^{th} order image of the wafer. When the “+2^{nd} order” is selected, the image corresponding to the “+2^{nd} order” is captured. The same applies to the “+1^{st} order”, “−1^{st} order”, and “+2^{nd} order” selections. The “save image” button instructs the system to save the captured wafer image. The system setting panel (170) further comprises wafer status window 176, in which the status of the wafer can be presented. The presented status can be a text input field for allowing the user to input texts of describing the wafer, or a display field showing the retrieved information of the wafer.

It will be appreciated by those of skill in the art that a new and useful method and a system for qualitatively evaluating product quality of microelectromechanical devices have been described herein. In view of the many possible embodiments to which the principles of this invention may be applied, however, it should be recognized that the embodiments described herein with respect to the drawing figures are meant to be illustrative only and should not be taken as limiting the scope of invention. For example, those of skill in the art will recognize that the illustrated embodiments can be modified in arrangement and detail without departing from the spirit of the invention. Therefore, the invention as described herein contemplates such embodiments as may come within the scope of the following claims and equivalents thereof.

1. A system for evaluating a quality of a plurality of microelectromechanical devices formed into a plurality of dies on a wafer, each microelectromechanical device having a deflectable reflective plate, and each die having an array of plates, the system comprising:
a light source providing a light beam;
an optics for collimating the light beam;
a wafer holder for holding the wafer such that the plates on the wafer reflect the light beam;
an image capture device that captures the reflected light from the microelectromechanical devices on the wafer and generates a set of images of the wafer, each wafer image corresponding to a beam of reflect light in a particular spatial direction; and
different wafer images correspond to reflected light in different directions; and
a means for comparing the brightness of the captured images to each other so as to qualitatively evaluate the micromirrors.

2. The system of claim 1, wherein the microelectromechanical device is a micromirror array device having an array of micromirrors, and wherein the deflectable reflective plate is a mirror plate of the micromirror.

3. The system of claim 1, wherein the wafer holder is equipped with a motor.

4. The system of claim 1, wherein the wafer holder has a supporting surface that is operable to tilt.

5. The system of claim 1, wherein the entire wafer is illuminated at a time.

7. The system of claim 1, wherein at least one entire die is fully illuminated at a time.

8. The system of claim 2, wherein each wafer image is generated by the reflected light from a plurality of micromirrors of the micromirror array having a center-to-center distance between adjacent micromirrors of from 4.38 to 10.16 micrometers.

9. The system of claim 2, wherein each wafer image is generated by the reflected light from a plurality of micromirrors of the micromirror array having a gap between adjacent micromirrors of from 0.1 to 0.5 micrometer.

10. The system of claim 2, wherein each image is generated by a light beam that travels through a glass substrate on which the micromirrors are formed.

11. The system of claim 2, wherein each image is generated by a light beam that is reflected by the mirror plates of the micromirror array that is formed on a semiconductor substrate.

12. The system of claim 2, wherein a wafer image of the image set is generated by the reflected light from a thousand or millions of micromirrors on the wafer.

13. The system of claim 2, wherein the image set has at least three wafer images generated by the reflected light form three different spatial directions.

14. The system of claim 13, wherein one of the three wafer images is associated with a number of micromirrors having mirror plates parallel to a substrate on which the micromirrors are formed.

15. The system of claim 13, wherein one of the three wafer images is associated with a number of micromirrors having mirror plates tilted in one direction from a substrate on which the micromirrors are formed.

16. The system of claim 13, wherein one of the three wafer images is associated with a number of micromirrors having mirror plates tilted in one direction from a substrate on which the micromirrors are formed.

17. The system of claim 2, wherein the image capture device is operable to capture images corresponding to different diffraction orders of the wafer.

18. A method of qualitatively evaluating the product quality of a wafer having a set of dies, each die having an array of micromirrors wherein each micromirror has a reflective deflectable mirror plate, the method comprising:
illuminating the wafer with a light beam;
capturing a set of wafer images, one of which is associated with a number of micromirrors having the mirror plates at a first angle relative to a substrate on which the micromirrors are formed, another one of which is associated with a number of micromirrors having the mirror plates at a second angle relative to the substrate, and yet another one of which is associated with a number of micromirrors having the mirror plates at yet a third angle relative to the substrate or parallel to the substrate; and
comparing the brightness of the captured images so as to qualitatively evaluate the micromirrors.

19. The method of claim 18, wherein the first angle is an angle wherein the mirror plates are rotated along a first direction, and the second angle is an angle wherein the mirror plates are rotated along a second direction that is opposite to the first direction.

21. The method of claim 18, further comprising:
generating the set of the wafer images by reflecting the light beam from a plurality of micromirrors of the micromirror array having a center-to-center distance between adjacent micromirrors of from 4.38 to 10.16 micrometers.

22. The method of claim 18, further comprising:
generating the set of the wafer images by reflecting the light beam from a plurality of micromirrors of the micromirror array having a gap between adjacent micromirrors of from 0.1 to 0.5 micrometer.

23. The method of claim 18, wherein each image is generated by a light beam that travels through a glass substrate on which the micromirrors are formed.

24. The method of claim 18, wherein each image is generated by a light beam that is reflected by the mirror plates of the micromirror array that is formed on a semiconductor substrate.

25. A method of qualitatively evaluating the product quality of a wafer having a set of dies, each die having an array of micromirrors, the method comprising:
accepting a set of controlling parameters from a user through a user-interface generated by a computer-executable program instructions; and
based on the received parameters, capturing a set of images of the dies on the wafer; and
qualitatively evaluating the uniformity of the illuminated dies based on a brightness distribution of the captured image of the dies.

26. The method of claim 25, wherein the step of capturing an image further comprise:
illuminating the die with a light beam; and
capturing a set of images, one of which is associated with a number of micromirrors having mirror plates tilted in one direction from a substrate on which the micromirrors are formed, another one of which is associated with a number of micromirrors having mirror plates tilted in another direction from the substrate, and yet another one of which is associated with a number of micromirrors having mirror plates tilted in another direction the substrate.

27. The method of claim 25, further comprising:
prompting a image display field; and
displaying the captured wafer image in the prompted image display field.

28. The method of claim 26, wherein the displayed image in the display field is an image of the wafer being measured.

29. The method of claim 26, wherein the displayed image in the display field is a stored image of a wafer.

30. The method of claim 25, wherein the step of accepting the set of parameters further comprises:
selecting an order for the image to be captured, wherein the order is associated with a beam of reflected light from a set of mirror plates having a particular tilted angle.

31. A computer-readable medium having computer executable instruction for performing a method of qualitatively evaluating the product quality of a wafer having a set of dies, each die having an array of micromirrors, wherein the method comprises:
accepting a set of controlling parameters from a user through a user-interface generated by the computer-executable program instructions; and
based on the received parameters, capturing an image of the die; and
qualitatively evaluating the uniformity of the illuminated die based on a brightness distribution of the captured image of the die.

32. A method of qualitatively evaluating the product quality of a wafer having a set of dies, each die having an array of micromirrors, the method comprising:
illuminating a die on the wafer with a light beam;
capturing an image of the illuminated die, wherein the image presents a brightness distribution; and
evaluating the uniformity of the micromirrors across the die based on the brightness distribution.

33. The method of claim 32, wherein the illuminated die on the wafer comprises an array of micromirrors that are formed on a light transmissive substrate.

34. The method of claim 33, wherein the light transmissive substrate is glass.

35. The method of claim 34, further comprising:
labeling the die as a “bad” die if the captured image has at least two regions having different brightness, and the brightness difference between the two regions is larger than a predetermined value.

36. The method of claim 34, further comprising:
labeling the die as a “good” die if the brightness variation across the dies is less than a predetermined value.

37. A method of qualitatively evaluating the product quality of a wafer having a set of dies, each die having an array of micromirrors, the method comprising:
illuminating a first and second die on the wafer with a light beam;
capturing an image for each of the illuminated dies, wherein each of the images presents a brightness distribution; and
evaluating the uniformity of the micromirrors across the wafer based on the brightness distributions of the dies.

38. A method of qualitatively evaluating the product quality of a wafer having a set of dies, each die having an array of micromirrors, the method comprising:
illuminating a first and second die on the wafer with a light beam;
capturing an image for each of the illuminated dies, wherein the image presents a brightness distribution; and
evaluating the uniformity of the micromirrors across the wafer based on a comparison of the brightness distributions of the dies to a predetermined brightness distribution.
